(19) United States
(12) Patent Application Publication
(10) Pub. No.: US 2026/0088675 A1
(43) Pub. Date: Mar. 26, 2026

(54) STATOR

(71) Applicant: TOYOTA JIDOSHA KABUSHIKI KAISHA, Toyota-shi (JP)

(72) Inventor: Kengo OHIRA, Toyota-shi (JP)

(73) Assignee: TOYOTA JIDOSHA KABUSHIKI KAISHA, Toyota-shi (JP)

(21) Appl. No.: 19/214,450

(22) Filed: May 21, 2025

(30) Foreign Application Priority Data
Sep. 24, 2024 (JP) 2024-164788

(51) Int. Cl. H02K 3/28

(52) U.S. Cl. CPC H02K 3/28

(57) ABSTRACT

In the stator of the present disclosure, at one end side of the stator core, the tip portions of the two legs protruding from one 2·i layer and the other 2·i−1 layer on one side in the circumferential direction of the first and second slots spaced apart by 6 slots are joined, and the end portions of the winding end portions of the 2·i layer and the winding start portions of the 2·i+1 layer are connected, the tip portions of the two legs protruding from one 2·i layer and the other 2·i+1 layer on one side in the circumferential direction of the first and second slots spaced apart by 6 slots are joined.

### CROSS-REFERENCE TO RELATED APPLICATION

This application claims priority to Japanese Patent Application No. 2024-164788 filed on Sep. 24, 2024. The disclosure of the above-identified application, including the specification, drawings, and claims, is incorporated by reference herein in its entirety.

### BACKGROUND

### 1. Technical Field

The present disclosure relates to a stator including a stator core including a plurality of slots and a plurality of stator coils wound around the stator core.

### 2. Description of Related Art

Conventionally, there has been known a stator including a stator core having a plurality of slots arranged in the circumferential direction and stator coils of three phases (U-phase, V-phase, and W-phase) wound around the stator core (see Japanese Patent No. 5896250 (JP 5896250 B), for example). In this stator, the three-phase stator coils each include a number of parallel windings (parallel coils) connected in parallel, the number being a multiple of four, and are connected by a Y-connection. Each parallel winding is formed by the following process. First, a pair of straight portions (legs) of a plurality of U-shaped conductor segments (segment coils) are inserted into corresponding slots. At this time, the conductor segments are inserted so as to protrude from one end side (twisting side) of the stator core in the axial direction. Then, the straight portions are twisted in the circumferential direction to join tip portions of the two corresponding straight portions. That is, the conductor segments include a first conductor segment, a second conductor segment, and a third conductor segment. The first conductor segment has a pair of straight portions inserted into two first slots, five slots away from each other. The second conductor segment has a pair of straight portions inserted into two second slots, seven slots away from each other on both sides of the first slots. The third conductor segment has a pair of straight portions inserted into a predetermined first slot and a predetermined second slot, six slots away from each other. The pair of straight portions of the first conductor segment is inserted into the (2·i−1)-th layer (i=3, 2, 1 in the example of JP 5896250 B) of one of the two first slots on one side (winding start side) in the circumferential direction and the (2·i)-th layer of the other. In addition, the pair of straight portions of the second conductor segment is inserted into the (2·i−1)-th layer of one of the two second slots on the one side in the circumferential direction and the (2·i)-th layer of the other such that the second conductor segment straddle the corresponding first conductor segment. Further, the pair of legs of the third conductor segment is inserted into the following positions. The positions are the (2·i)-th layer of one of the predetermined first slot and the predetermined second slot, six slots away from each other, on the one side in the circumferential direction and the (2·i+1)-th layer of the other. The pair of legs of the third conductor segment form a crossover wire (57) that straddles between the (2·i)-th layer and the (2·i+1)-th layer on the other end side (the side opposite to the twisting side) of the stator core. On the one end side of the stator core, two legs protruding from the (2·i)-th layer of one of two slots, six slots away from each other, on one side in the circumferential direction and the (2·i−1)-th layer of the other are twisted to join tip portions of the two legs. Thus, in each of the parallel windings, the straight portions of the conductor segments are evenly disposed in both the first and second slots adjacent to each other in the circumferential direction. This makes it possible to suppress a circulating current being generated in each of the parallel windings by eliminating deviation in the timing at which an induced voltage is generated in each of the magnetic poles of the parallel windings in response to the passage of the magnet of the rotor.

In addition, conventionally, there has been known an annular alignment device for segment coils that annularly aligns a plurality of segment coils each having first and second end portions (legs) connected to each other via a bent portion or a curved portion (see Japanese Patent No. 3975891 (JP 3975891 B), for example). The annular alignment device includes an alignment annular portion, a segment coil insertion portion, and a coil guide portion. The alignment annular portion includes housing grooves disposed at a predetermined pitch along the outer peripheral side of a cylindrical shape to open in one direction of a cylindrical shaft and support the segment coils so as to be rotatable with a first end portion as a rotation axis, and performs an annular rotation movement about the cylindrical shaft. The segment coil insertion portion inserts a first end portion of the segment coil for each at least one housing groove following the rearmost end of the housing groove into which the first end portion is inserted, according to the annular rotation movement of the alignment annular portion. The coil guide portion guides a second end portion of the segment coil, the first end portion of which is inserted into the housing groove, to another housing groove, different from the housing groove into which the first end portion of the segment coil is inserted, according to the annular rotation movement of the alignment annular portion. In such an annular alignment device, the insertion of the first end portion of the segment coil into the housing groove and the guiding of the second end portion of the segment coil to the housing groove are performed concurrently according to the annular rotation movement of the alignment annular portion. Thus, it is possible to align the segment coils in an annular shape by aligning the inclination direction of the bent portion or the curved portion of the segment coils with respect to the radial direction of the stator core while reducing the working time.

### SUMMARY

In an electric motor including a stator such as that described in JP 5896250 B, the output characteristic is changed according to the number of turns (hereinafter referred to as a “number of effective turns”) obtained by dividing the number of straight portions (number of layers) in each slot by the number of parallel windings, and a stator with a non-integer number (e.g., 1.5 or 2.5) of turns may be required from the side on which the electric motor is mounted. According to the stator described in JP 5896250 B, it is possible to suppress a circulating current being generated between a plurality of parallel windings, even if the number of effective turns is a non-integer number. However, in the stator described in JP 5896250 B, the inclination direction of the portion connecting the legs of the third conductor segment (portion forming a crossover wire) with respect to the radial direction of the stator core is opposite to the first and second conductor segments. Therefore, it is not possible to arrange the first to third conductor segments in an annular shape using an annular arrangement device such as that described in JP 3975891 B. Therefore, it is necessary to assemble the third conductor segment to the stator using a multi-axis robot or the like, which may incur a reduction in productivity of the stator or an increase in manufacturing cost.

Thus, it is a main object of the present disclosure to provide a stator capable of suppressing generation of a circulating current even if the number of effective turns is a non-integer number, and capable of improving productivity and reducing a manufacturing cost.

An aspect of the present disclosure provides a stator including:
a stator core including a plurality of slots formed at intervals in a circumferential direction so as to extend in a radial direction; and
a plurality of segment coils that has a pair of legs inserted into different slots and that forms
a plurality of stator coils by electrical connection between tip portions of the corresponding legs, in which:
when a number of poles is “p” and a number of the slots is “n”, n=6·p is satisfied;
the stator coils include 4·m (where “m” is an integer of 1 or more) parallel coils connected in parallel;
an even number of the legs are inserted into each of the slots, side by side in the radial direction;
the segment coils include
a first segment coil having a pair of legs inserted into a (2·i−1)-th layer (where “i” is an integer greater than or equal to 1, i=1, . . . , imax) of one of two first slots, five slots away from each other, on one side in the circumferential direction and a (2·i)-th layer of the other so as to protrude from one end of the stator core,
a second segment coil having a pair of legs inserted into the (2·i−1)-th layer of one of two second slots, seven slots away from each other on both sides of the first slots, on the one side in the circumferential direction and the (2·i)-th layer of the other so as to protrude from the one end of the stator core, the second segment coil straddling the corresponding first segment coil, and
a third segment coil having a pair of legs inserted into the (2·i−1)-th layer of one of a predetermined first slot and a predetermined second slot, six slots away from each other, on the one side in the circumferential direction and the (2·i) layer of the other so as to protrude from the one end of the stator core, the third segment coil forming a winding end portion in the (2·i)-th layer or a winding start portion in a (2·i+1)-th layer; and
on a side of the one end of the stator core, two legs protruding from the (2·i)-th layer of one of the first and second slots, six slots away from each other, on the one side in the circumferential direction and the (2·i−1)-th layer of the other are twisted to join tip portions of the two legs, and two legs protruding from the (2·i)-th layer of one of the first and second slots, six slots away from each other, on the one side in the circumferential direction and the (2·i+1)-th layer of the other are twisted to join tip portions of the two legs so that the winding end portion of the (2·i)-th layer and the winding start portion of the (2·i+1)-th layer are connected.

The stator of the present disclosure includes a first segment coil, a second segment coil, and a third segment coil. The first segment coil has a pair of legs inserted into two first slots, five slots away from each other. The second segment coil has a pair of legs inserted into two second slots, seven slots away from each other on both sides of the first slots. The third segment coil has a pair of legs inserted into a predetermined first slot and a predetermined second slot, six slots away from each other. The legs of the first segment coil are inserted into the (2·i−1)-th layer of one of the two first slots on one side in the circumferential direction and the (2·i)-th layer of the other so as to protrude from one end of the stator core. The legs of the second segment coil are inserted into the (2·i−1)-th layer of one of the two second slots on the one side in the circumferential direction and the (2·i)-th layer of the other. At this time, the legs of the second segment coil are inserted so as to protrude from the one end of the stator core. The second segment coil straddles the corresponding first segment coil. The legs of the third segment coil are inserted into the (2·i−1)-th layer of one of the predetermined first slot and the predetermined second slot on the one side in the circumferential direction and the (2·i)-th layer of the other. At this time, the legs of the third segment coil are inserted so as to protrude from the one end of the stator core. The legs of the third segment coil form a winding end portion in the (2·i)-th layer or a winding start portion in the (2·i+1)-th layer. Further, on the side of the one end of the stator core, the two legs protruding from the (2·i)-th layer of one of the first and second slots, six slots away from each other, on the one side in the circumferential direction and the (2·i−1)-th layer of the other are joined to each other. The two legs are twisted to join the tip portions of the two legs. Further, on the side of the one end of the stator core, the winding end portion of the (2·i)-th layer and the winding start portion of the (2·i+1)-th layer are connected. Specifically, the two legs protruding from the (2·i)-th layer of one of the first and second slots, six slots away from each other, on the one side in the circumferential direction and the (2·i+1)-th layer of the other are joined to each other. The two legs are twisted to join the tip portions of the two legs.

That is, in each parallel coil, the second segment coil is inserted into two second slots, seven slots away from each other, so as to straddle the first segment coil inserted into two first slots, five slots away from each other. Then, on the side of the one end of the stator core, the corresponding legs are joined to each other at a pitch of six slots, thereby forming each parallel coil. Thus, a circulating current generated due to the deviation of the timing at which the induced voltage is generated in each magnetic pole of the parallel coil in response to the passage of the magnet of the rotor is cancelled out in each parallel winding, even if the number of effective turns is a non-integer number. As a result, it is possible to suppress a circulating current flowing through the stator coil. Further, in the stator of the present disclosure, the inclination direction of the portion (crossover wire portion) connecting the legs of the third segment coil with respect to the radial direction of the stator core is the same as the first and second segment coils. Therefore, the first to third segment coils wound in the (2·i−1)-th layer and the (2·i)-th layer can be assembled to the stator core after being arranged in an annular shape by a known annular arrangement device. Thus, it is possible to shorten the takt time and reduce the cost by omitting the use of a multi-axis robot or the like. As a result, with the stator of the present disclosure, it is possible to suppress generation of a circulating current even if the number of effective turns is a non-integer number, and to improve productivity and reduce a manufacturing cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a stator of the present disclosure;

FIG. 2 is a schematic diagram illustrating an example of a stator coil of the stator of the present disclosure;

FIG. 3 is a schematic configuration diagram illustrating a segment coil forming a stator coil of a stator of the present disclosure;

FIG. 4 is an explanatory view illustrating an assembly mode of the segment coil to the stator core of the stator of the present disclosure;

FIG. 5 is an explanatory view illustrating an assembly mode of the segment coil to the stator core of the stator of the present disclosure;

FIG. 6 is an explanatory view illustrating an assembly mode of the segment coil to the stator core of the stator of the present disclosure;

FIG. 7 is a perspective view of an assembly of a segment coil;

FIG. 8 is a perspective view illustrating an assembly procedure of the segment coil assembly with respect to the stator core;

FIG. 9 is an enlarged perspective view illustrating a main part of the stator of the present disclosure; and

FIG. 10 is a schematic view showing another stator coil applicable to the stator of the present disclosure.

### DETAILED DESCRIPTION OF EMBODIMENTS

Embodiments of the present disclosure will now be described with reference to the drawings.

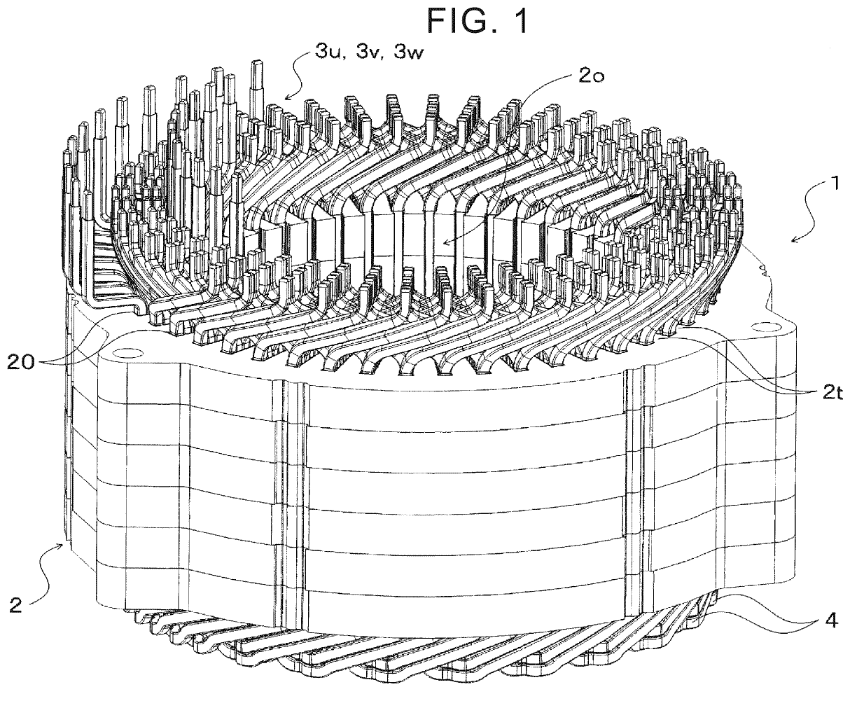

FIG. 1 is a perspective view showing a stator 1 of the present disclosure.

The stator 1 shown in the figure constitutes a three-phase AC motor (rotary electric machine) together with a rotor (not shown). The rotary electric machine is used, for example, as a traveling drive source or a generator of a battery electric vehicle or a hybrid electric vehicle. In the present embodiment, the stator 1 includes an annular stator core 2, a stator coil 3u (U-phase coil), a stator coil 3v (V-phase coil), and a stator coil 3w (W-phase coil).

The stator core 2 of the stator 1 is connected in the laminating direction by laminating a plurality of electromagnetic steel sheets formed in a substantially annular shape by, for example, press working, or is formed in an annular shape by, for example, pressing and sintering the ferromagnetic powder. As shown in FIG. 1, the stator core 2 includes a center hole 20 in which the rotor is disposed, a plurality of tooth portions 2t, and a plurality of (for example, 48 in the present embodiment) slots 20. The plurality of tooth portions 2t extend in the radial direction from the ring-shaped outer peripheral portion (yoke portion) toward the axial center and are adjacent to each other at regular intervals in the circumferential direction. The plurality of slots 20 are formed between adjacent teeth 2t. Each of the plurality of slots 20 extends in the radial direction of the stator core 2 and is arranged in the circumferential direction at regular intervals, and opens at the center hole 20. In addition, an insulator (insulating paper) (not shown) is disposed in each slot 20. Further, the stator 1, the same number of magnetic poles (in the present embodiment, eight) of the magnetic poles of the rotor is formed, the number of magnetic poles of the stator 1 (the number of poles) is “p”, the number of slots 20 is “n”, the relationship of n=6·p is established.

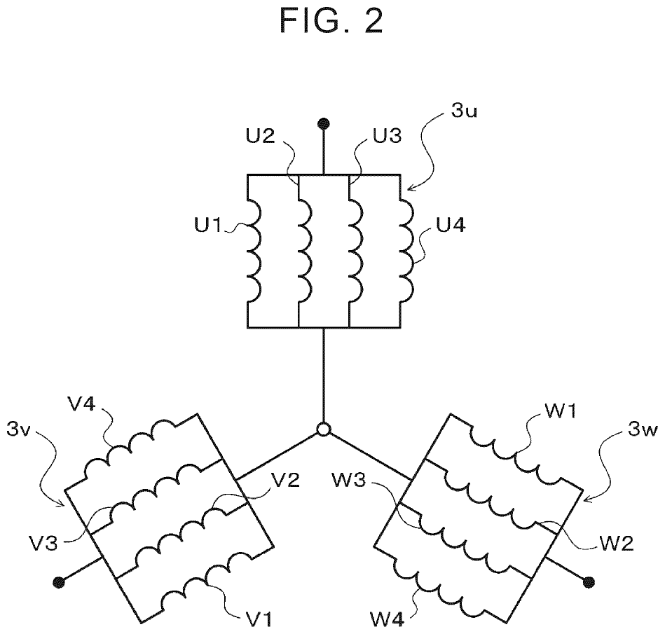

The stator coil 3u, 3v, 3w is formed by electrically joining a plurality of segment coils (coil wires) 4. As shown in FIG. 2, the stator coil 3u includes four parallel coils U1, U2, U3, and U4 electrically connected in parallel. The stator coil 3v also includes four parallel coils V1, V2, V3, and V4 electrically connected in parallel with each other, and the stator coil 3w includes four parallel coils W1, W2, W3, and W4 electrically connected in parallel with each other. As shown in FIG. 2, the stator coils 3u, 3v, 3w are connected to each other by star connection (Y connection). That is, the parallel coils U1-U4, V1-V4, and W1-W4 are connected to each other by so-called 4Y connection.

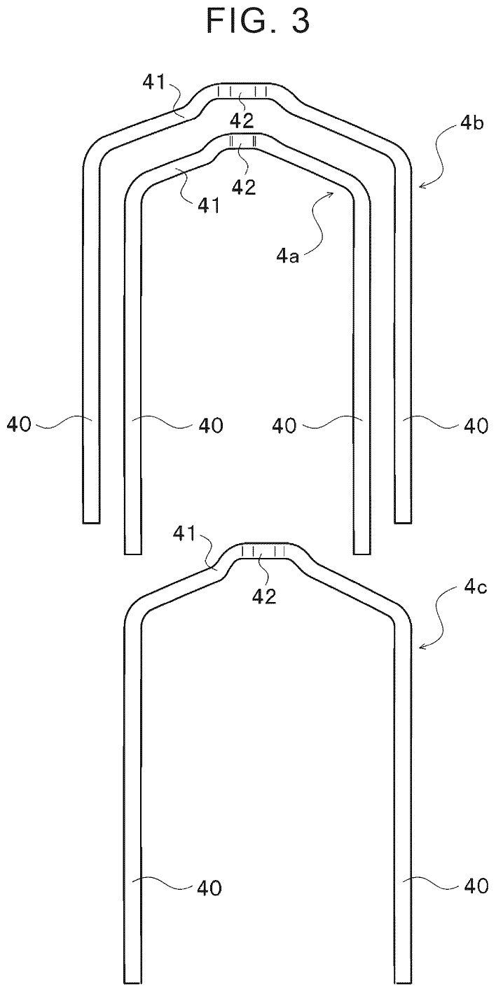

The segment coil 4 is, for example, an electrical conductor formed by bending a flat wire having an insulating film made of enamel resin formed on its surface in a flat-wise direction and an edgewise direction. In the present embodiment, as shown in FIG. 3, the segment coil 4 includes a first segment coil 4a, a second segment coil 4b, and a third segment coil 4c. The first-third segment coil 4a, 4b, 4c is formed in a substantially U-shape, and has a pair of (two) legs 40 and a crossover wire portion 41 connecting the pair of legs 40 to each other. Further, the crossover wire portion 41 of the first-third segment coil 4a, 4b, 4c, the crank portion 42 is formed so as to extend obliquely between the two flat-wise bent portions. The two legs 40 of the first-third segment coil 4a, 4b, 4c are inserted from the other end of the stator core 2 into the slots 20 that differ from each other so as to protrude from one end (upper end in FIG. 1) of the stator core 2. The crossover wire portions 41 of the first to third segment coil 4a, 4b, 4c are aligned at the other end of the stator core 2.

In the present embodiment, the first to third segment coil 4a, 4b, 4c are assembled to the stator core 2 such that an even number (six in the present embodiment) of the legs 40 protrude radially adjacent to each of the plurality of slots 20. Then, a plurality of layers is formed by the plurality of legs 40. The plurality of legs 40 protrude from each of the plurality of slots 20 and are adjacent to each other in the circumferential direction of the stator core 2. Hereinafter, the layers of the plurality of legs 40 (tip portions) adjacent to each other in the circumferential direction on the outermost peripheral side of the stator core 2 are referred to as “first layers”, the radially inner layers are referred to as “second layers”, “third layers”, . . . , and the layers of the plurality of legs 40 adjacent to each other in the circumferential direction on the innermost peripheral side are referred to as “sixth layers”. The number of “layers” in the stator 1 corresponds to the number of legs 40 arranged in each slot 20.

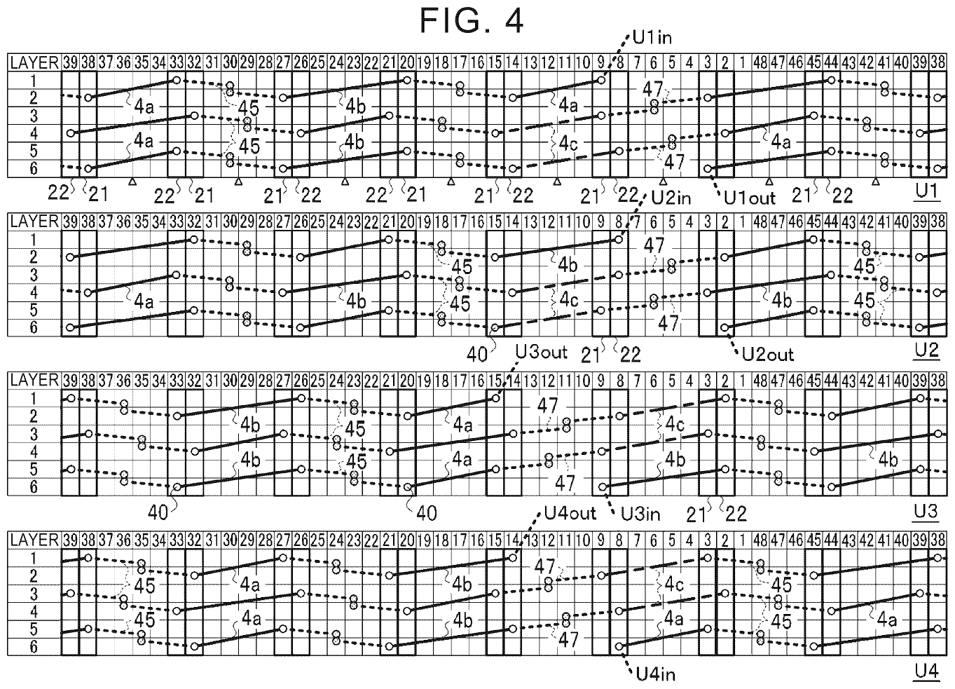

Next, referring to FIG. 4, an assembly mode of the first-third segment coil 4a, 4b, 4c with respect to the stator core 2 will be described, taking the stator coil 3u as an example. As shown in FIG. 4, the pair of legs 40 of the first segment coil 4a is inserted from the other end side of the stator core 2 (the front side of the drawing in FIG. 4). At this time, the pair of legs 40 protrudes from one end of the stator core 2 (the back side in FIG. 4) to one of the two i−1 layers and the other of the two i layers on one side (the winding start side) in the circumferential direction of the two first slots 21 separated by five slots. Here, “i” is an integer of 1 or more, and i=1, . . . , imax (in the present embodiment, imax=3).

More specifically, the pair of legs 40 of the first segment coil 4a forming the parallel coil U1 of the stator coil 3u is inserted into the following positions, as shown in FIG. 4: the first layer of slot No. 9 and the second layer of slot No. 14; the first layer of slot No. 33 and the second layer of slot No. 38; the third layer of slot No. 21 and the fourth layer of slot No. 26; the third layer of slot No. 45 and the fourth layer of slot No. 2; and the fifth layer of slot No. 33 and the sixth layer of slot No. 38. Also, as shown in FIG. 4, the pair of legs 40 of the first segment coil 4a forming the parallel coil U2 are inserted in the following positions: the first layer of slot No. 21 and the second layer of slot No. 26; the first layer of slot No. 45 and the second layer of slot No. 2; the third layer of slot No. 33 and the fourth layer of slot No. 38; the fifth layer of slot No. 21 and the sixth layer of slot No. 26; and the fifth layer of slot No. 45 and the sixth layer of slot No. 2.

Further, the pair of legs 40 of the first segment coil 4a forming the parallel coil U3 are inserted into the following positions as shown in FIG. 4: the first layer of slot No. 15 and the second layer of slot No. 20; the first layer of slot No. 39 and the second layer of slot No. 44; the third layer of slot No. 27 and the fourth layer of slot No. 32; the fifth layer of slot No. 15 and the sixth layer of slot No. 20; and the fifth layer of slot No. 39 and the sixth layer of slot No. 44. Also, as shown in FIG. 4, the pair of legs 40 of the first segment coil 4a forming the parallel coil U4 are inserted in the following positions: the first layer of slot No. 27 and the second layer of slot No. 32; the third layer of slot No. 15 and the fourth layer of slot No. 20; the third layer of slot No. 39 and the fourth layer of slot No. 44; the fifth layer of slot No. 27 and the sixth layer of slot No. 32; and the fifth layer of slot No. 3 and the sixth layer of slot No. 8.

The pair of legs 40 of the second segment coil 4b is inserted into one of the two i−1 layers and the other 2·i layers on one side (winding start side) in the circumferential direction of the two second slots 22 separated by seven slots on both sides of the first slot 21. At this time, the pair of legs 40 is inserted from the other end side of the stator core 2 so as to protrude from one end of the stator core 2. The crossover wire portion 41 of the second segment coil 4b straddles the crossover wire portion 41 of the corresponding first segment coil 4a. More specifically, the pair of legs 40 of the second segment coil 4b forming the parallel coil U1 of the stator coil 3u is inserted into the following positions as shown in FIG. 4: the first layer of slot No. 20 and the second layer of slot No. 27; the first layer of slot No. 44 and the second layer of slot No. 3; the third layer of slot No. 32 and the fourth layer of slot No. 39; the fifth layer of slot No. 20 and the sixth layer of slot No. 27; and the fifth layer of slot No. 44 and the sixth layer of slot No. 3. Also, as shown in FIG. 4, the pair of legs 40 of the second segment coil 4b forming the parallel coil U2 are inserted into the following positions: the first layer of slot No. 8 and the second layer of slot No. 15; the first layer of slot No. 32 and the second layer of slot No. 39; the third layer of slot No. 20 and the fourth layer of slot No. 27; the third layer of slot No. 44 and the fourth layer of slot No. 3; and the fifth layer of slot No. 32 and the sixth layer of slot No. 39.

Further, the pair of legs 40 of the second segment coil 4b forming the parallel coil U3 are inserted into the following positions as shown in FIG. 4: the first layer of slot No. 26 and the second layer of slot No. 33; the third layer of slot No. 14 and the fourth layer of slot No. 21; the third layer of slot No. 38 and the fourth layer of slot No. 45; the fifth layer of slot No. 26 and the sixth layer of slot No. 33; and the fifth layer of slot No. 2 and the sixth layer of slot No. 9. Also, as shown in FIG. 4, the pair of legs 40 of the second segment coil 4b forming the parallel coil U4 are inserted into the following positions: the first layer of slot No. 14 and the second layer of slot No. 21; the first layer of slot No. 38 and the second layer of slot No. 45; the third layer of slot No. 26 and the fourth layer of slot No. 33; the fifth layer of slot No. 14 and the sixth layer of slot No. 21; the fifth layer of slot No. 38 and the sixth layer of slot No. 45.

The pair of legs 40 of the third segment coil 4c is inserted into one of the two i−1 layers and the other of the two i layers on one side (winding start side) in the circumferential direction of the predetermined first and second slots 21 and 22 separated by six slots. At this time, the pair of legs 40 is inserted from the other end side of the stator core 2 so as to protrude from one end of the stator core 2. One of the pair of legs 40 forms a winding end in the 2·i layer or a winding start in the 2·i+1 (=2·(i+1)−1) layer. That is, the parallel coil U1 of the stator coil 3u includes two third segment coil 4c. As shown in FIG. 4, the pair of legs 40 of the third segment coil 4c of one of the parallel coil U1 is inserted into the third layer of the ninth slot and the fourth layer of the fifteenth slot, and forms a winding start portion in the third layer (2·i+1 layer). As shown in FIG. 4, the pair of legs 40 of the other third segment coil 4c of the parallel coil U1 is inserted into the fifth layer of the eighth slot and the sixth layer of the fourteenth slot, and forms a winding start portion in the fifth layer (2·i+1 layer).

The parallel coil U2 of the stator coil 3u includes two third segment coils 4c. As shown in FIG. 4, the pair of legs 40 of the third segment coil 4c of one of the parallel coil U2 is inserted into the third layer of the eighth slot and the fourth layer of the fourteenth slot to form a winding start portion in the third layer (2·i+1 layer). Further, the pair of legs 40 of the other third segment coil 4c of the parallel coil U2, as shown in FIG. 4, is inserted into the sixth layer of the fifth layer and the fifteenth slot of the ninth slot, to form a winding start portion in the fifth layer (2·i+1 layer). The parallel coil U3 of the stator coil 3u includes two third segment coils 4c. As shown in FIG. 4, the pair of legs 40 of the third segment coil 4c of one of the parallel coil U3 is inserted into the first layer of the second slot and the second layer of the eighth slot to form a winding end portion of the second layer (2·i layer). Further, the pair of legs 40 of the other third segment coil 4c of the parallel coil U3 is inserted into the third layer of the third slot and the fourth layer of the ninth slot, as shown in FIG. 4, to form a winding end portion in the fourth layer (2·i layer). The parallel coil U4 of the stator coil 3u includes two third segment coils 4c. As shown in FIG. 4, the pair of legs 40 of the third segment coil 4c of one of the parallel coil U4 is inserted into the first layer of the third slot and the second layer of the ninth slot to form a winding end portion in the second layer (2·i layer). Further, the pair of legs 40 of the other third segment coil 4c of the parallel coil U4 is inserted into the third layer of the second slot and the fourth layer of the eighth slot, as shown in FIG. 4, to form a winding end portion in the fourth layer (2·i layer).

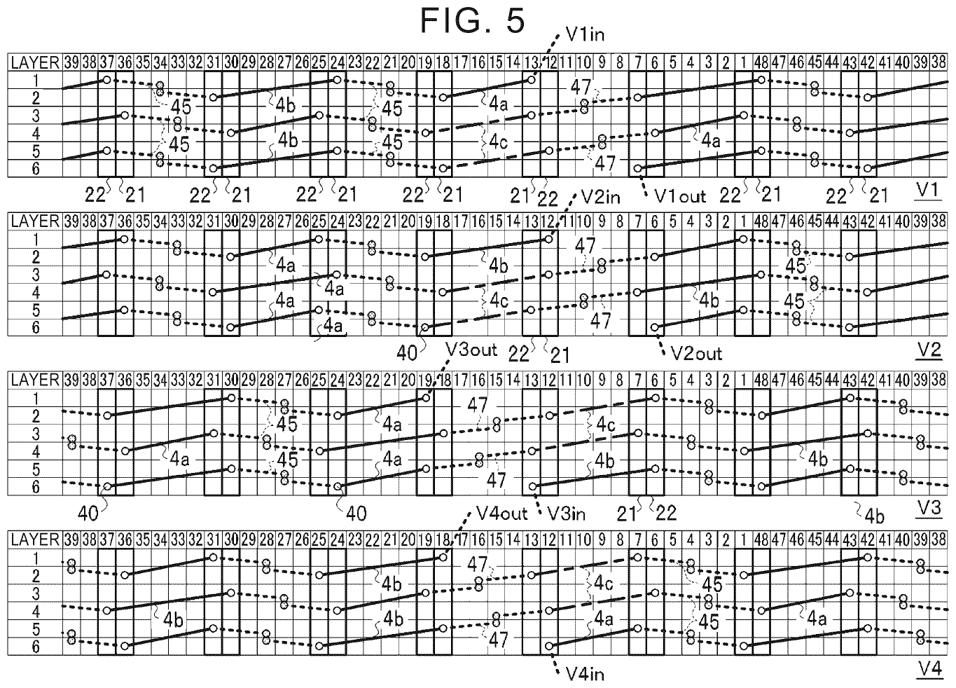

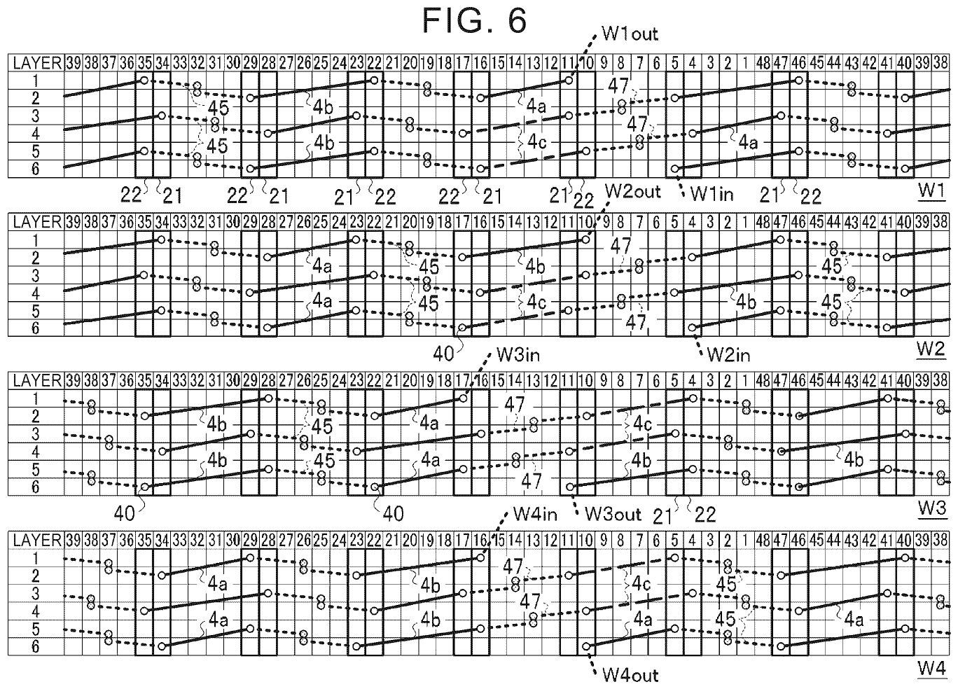

The first-third segment coil 4a, 4b, 4c forming the parallel coil V1-V4 of the stator coil 3v are assembled in a four-slot offset manner with respect to the first-third segment coil 4a, 4b, 4c forming the U-phase parallel coil U1-U4. As shown in FIG. 5, the deviating direction is one side (left side in FIGS. 4 and 5) in the circumferential direction. Furthermore, the first-third segment coil 4a, 4b, 4c forming the parallel coil W1-W4 of the stator coil 3w are assembled in a two-slot offset manner with respect to the first-third segment coil 4a, 4b, 4c forming the U-phase parallel coil U1-U4. As shown in FIG. 6, the shift direction is one side (left side in FIGS. 4 and 5) in the circumferential direction.

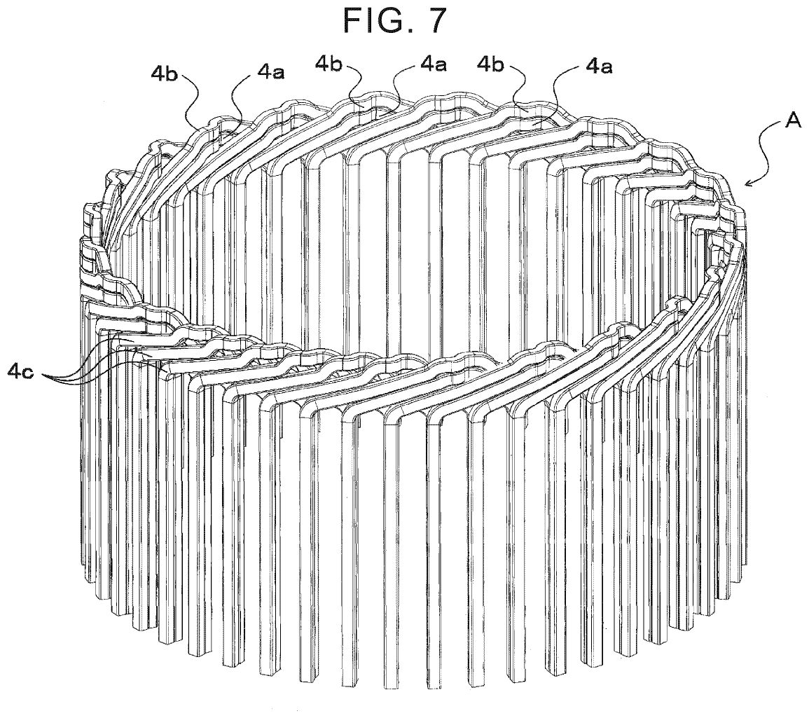

As can be seen from FIGS. 4 to 6, the inclination direction of the crossover wire portion 41 (crank portion 42) of the first and second segment coil 4a, 4b with respect to the radial direction of the stator core 2 is the same direction, and the inclination direction of the crossover wire portion 41 (crank portion 42) of the third segment coil 4c with respect to the radial direction of the stator core 2 is also the same direction as the first and second segment coil 4a, 4b. Thus, the two i−1 layers and the two-i layers of the plurality of slots 20, i.e., the first and second layers, the third and fourth layers, and the first-third segment coil 4a, 4b, 4c wrapped around the fifth and sixth layers can be arranged in a circular ring arrangement as shown in FIG. 7 by known annular arrangement devices. Known annular arrangement devices are disclosed, for example, in U.S. Pat. No. 3,975,891.

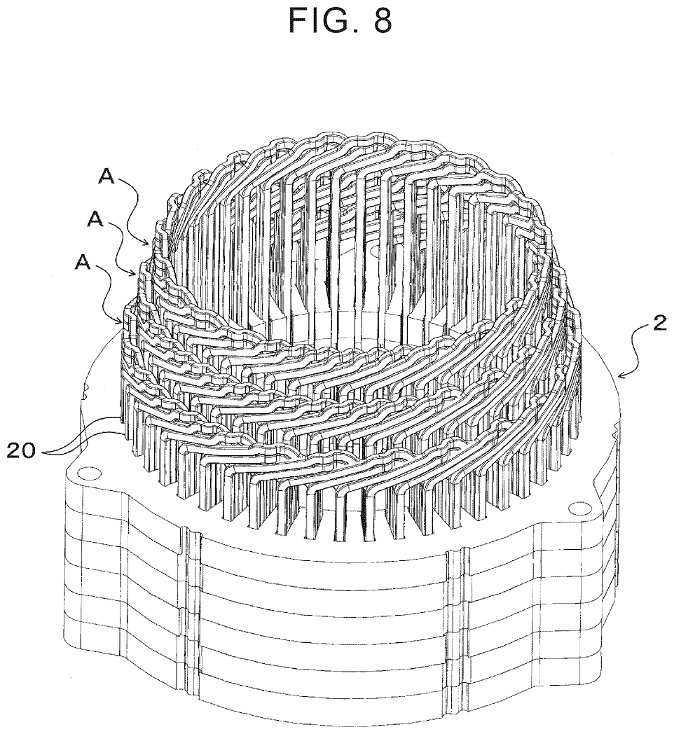

In the assembly A in which the first to third segment coils 4a, 4b, 4c of the two layers are arranged in an annular shape, the segment coils are arranged as follows. The second segment coils 4b are disposed so as to straddle the crossover wire portions 41 of the corresponding first segment coils 4a. The plurality of (six) third-segment coil 4c are circumferentially arranged so that the crossover wire portions 41 overlap each other. Consequently, as shown in FIG. 8, three assemblies A (first to third segment coil 4a, 4b, 4c) wound around the first and second layers, the third and fourth layers, and the fifth and sixth layers can be sequentially assembled to the stator core 2. In the present embodiment, as can be seen from FIG. 8, the first to third segment coils 4a, 4b, 4c include three types of segment coils that differ in the circumferential spacing of the pair of legs 40.

After the assembly of the first to third segment coil 4a, 4b, 4c with respect to the stator core 2 is completed, the legs 40 of the first to third segment coil 4a, 4b, 4c protruding from one end (twist-side) of the stator core 2 are twisted. The twisting is performed by using a twisting device (not shown). In the present embodiment, the pair of legs 40 of the first-third segment coil 4a, 4b, 4c are twisted circumferentially away from each other (see broken lines in FIGS. 4 to 6). As can be seen from FIGS. 4 to 6, the two legs 40 of the first and second segment coil 4a, 4b protrude from one 2·i layer and the other 2·i−1 layer on one side (winding start side) in the circumferential direction of the first and second slots 21 and 22 separated by 6 slots. For example, the two legs 40 of the first and second segment coiled 4a, 4b protrude from the second layer of slot 14, the first layer of slot 20, and the like. The tips of the two legs 40 of the first and second segment coil 4a, 4b are electrically joined by welding (e.g., laser welding, etc.).

As a result, a plurality of crossover wire portions 45 connecting the corresponding distal end portions of the first and second segment coil 4a, 4b are formed at one end of the stator core 2. As can be seen from FIGS. 4 to 6, the direction in which the crossover wire portions 45 straddle the layers at one end side of the stator core 2 is opposite to the direction in which the crossover wire portions 41 of the first-third segment coil 4a, 4b, 4c straddle the layers at the other end side of the stator core 2. For example, a direction in which the crossover wire portion 45 straddles the layer is a direction from the 2·i layer toward the 2·i−1 layer, and a direction in which the crossover wire portion 41 straddles the layer is a direction from the 2·i−1 layer toward the 2·i layer. Note that prior to welding, the insulating coating is removed from the tip of each leg 40 so that the conductor is exposed.

Further, as shown in FIGS. 4 to 6, at one end of the stator core 2, the leg 40 of the third segment coil 4c forming the winding end portion in the 2·i layer, the leg 40 of the third segment coil 4c forming the winding start portion in the 2·i+1 layer is connected. That is, the two legs 40 protrude from one 2·i layer and the other 2·i+1 layer on one side (winding start side) in the circumferential direction of the first and second slots 21 and 22 separated by 6 slots. The two legs 40 are twisted to electrically join the tips of the two by welding. The two legs 40 protrude from, for example, the second layer of the third slot and the third layer of the ninth slot, and the fifth layer of the fourth layer and the eighth slot of the second slot.

More specifically, on one end side of the stator core 2, the legs 40 of the third segment coil 4c protrude from one of the 2·i+1 layers on one side (winding start side) in the circumferential direction of the predetermined first and second slots 21 and 22. The legs 40 of the first or second segment coil 4a, 4b then protrude from the 2·i layers of the slots 20 that are spaced by 6 slots from one of the predetermined first and second slots 21, 22. The legs 40 of the third segment coil 4c and the legs 40 of the first or second segment coil 4a, 4b are twisted to electrically join their tips. The predetermined first and second slots 21 and 22 are, for example, slot number 9 and slot number 15, slot number 8 and slot number 14 in FIG. 4. The legs 40 of the third segment coiled 4c project, for example, from the third layer of slot 9 or the fifth layer of slot 8 in FIG. 4. One of the predetermined first and second slots 21 and 22 is, for example, a No. 9 slot or a No. 8 slot in FIG. 4. The legs 40 of the first or second segment coil 4a, 4b project, for example, from the second layer of the third slot or the fourth layer of the second slot in FIG. 4. Further, on one end side of the stator core 2, the legs 40 of the third segment coil 4c protrude from the other 2·i layer on the other side opposite to the one side (winding start side) of the predetermined first and second slots 21 and 22. The legs 40 of the first or second segment coil 4a, 4b then protrude from the 2·i+1 layers of the slots 20 spaced by 6 slots from the other of the predetermined first and second slots 21, 22. Then, the legs 40 of the third segment coil 4c and the legs 40 of the first or second segment coil 4a, 4b are twisted to electrically join the tips of both. The predetermined first and second slots 21 and 22 are, for example, slots No. 2 and No. 8 in FIG. 4, and slots No. 3 and No. 9. The legs 40 of the third segment coiled 4c protrude, for example, from the second layer or the fourth layer of slot 8 or slot 9 in FIG. 4. The legs 40 of the first or second segment coil 4a, 4b project, for example, from the third layer of slot 14 or the third layer of slot 15 in FIG. 4.

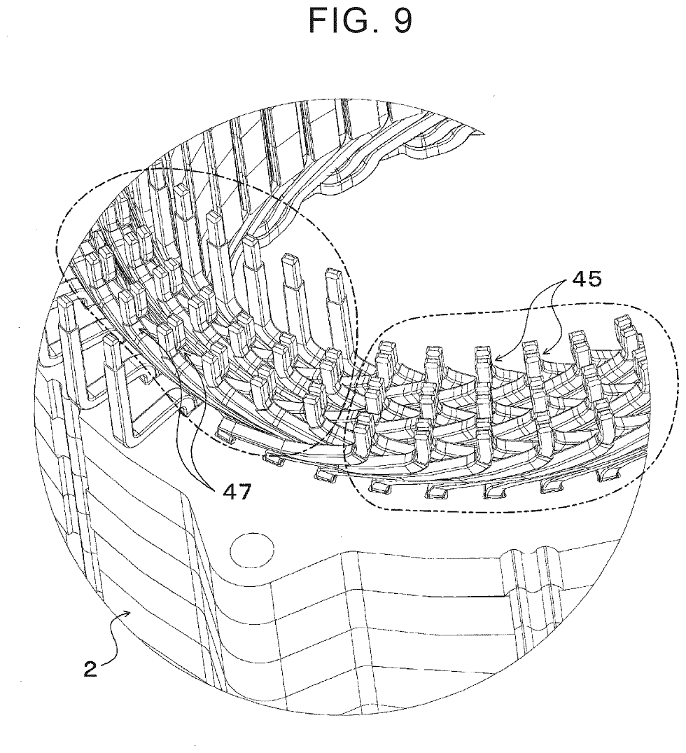

As a result, a plurality of crossover wire portions 47 are formed on one end side of the stator core 2 (see a range surrounded by a dashed-dotted line in FIG. 9). The crossover wire portion 47 connects the leg 40 of the third segment coil 4c forming the winding end portion in the 2·i layer and the leg 40 of the first or second segment coil 4a, 4b forming the winding start portion in the 2·i+1 layer. Alternatively, the crossover wire portion 47 connects the leg 40 of the first or second segment coil 4a, 4b forming the winding end portion in the 2·i layer and the leg 40 of the third segment coil 4c forming the winding start portion in the 2·i+1 layer. As can be seen from FIGS. 4 to 6, on one end side of the stator core 2, the direction in which each crossover wire portion 47 straddles the layer (the direction from the 2·i layer toward the 2·i+1 layer) is opposite to the direction in which the other crossover wire portion 45 (see the area surrounded by the two-dot chain line in FIG. 9) straddles the layer (the direction from the 2·i−1 layer toward the 2·i layer).

When the joining of the tips of the corresponding legs 40 is completed, the first and third segment coiled 4a, 4b, 4c are wound around the first and second layers, the third and fourth layers, and the fifth and sixth layers by wave winding. Further, the legs 40 inserted into the first layer and the sixth layer of the No. 8 and No. 9 slots are used as lead wires of the parallel coil U1, U2, U3, and U4, as shown in FIG. 4. These legs 40 are electrically connected to a U-phase power line via a bus bar unit (not shown) on one end side of the stator core 2. Further, the legs 40 inserted into the sixth layer of slots 2 and 3 and the first layer of slots 14 and 15 are utilized as the neutral lines of the parallel coiled U1, U2, U3, and U4, as shown in FIG. 4. These feet 40 are electrically connected to a neutral point via a busbar unit (not shown).

Further, the legs 40 inserted into the first layer and the sixth layer of the 12th and 13th slots are used as the lead wires of the parallel coil V1, V2, V3, and V4, as shown in FIG. 4. These legs 40 are electrically connected to a V-phase power line via a bus bar unit (not shown) on one end side of the stator core 2. Furthermore, the legs 40 plugged into the sixth layer of slots 6 and 7 and the first layer of slots 18 and 19 are utilized as the neutral lines of the parallel coiled V1, V2, V3, and V4, as shown in FIG. 4. These legs 40 are electrically connected to a neutral point via a busbar unit (not shown). Further, the legs 40 inserted into the sixth layers of the fourth and fifth slots and the first layers of the sixteenth and seventeenth slots are used as the lead wires of the parallel coil W1, W2, W3, and W4, as shown in FIG. 4. These legs 40 are electrically connected to the W-phase power line via a bus bar unit (not shown) at one end side of the stator core 2. Further, the legs 40 plugged into the first and sixth layers of the tenth and eleventh slots are utilized as the neutral lines of the parallel coils W1, W2, W3, and W4 as shown in FIG. 4 and are electrically connected to the neutral points via a busbar unit (not shown). As a result, the plurality of stator coil 3u, 3v, 3w is wound around the stator core 2 by distributed winding.

In the plurality of stator coil 3u, 3v, 3w wound around the stator core 2, the joint portions between the distal end portions of the plurality of legs 40 form an annular first coil end portion that protrudes outward from the end surface of one end of the stator core 2 in a radial direction by a predetermined number. In the stator 1, as can be seen from FIGS. 1 and 4 to 6, the legs 40 used as lead wires and neutral wires can be aggregated within a relatively narrow range of the first coil end portion. Thus, when the electric motor including the stator 1 is cooled by the cooling liquid (cooling oil), it is possible to dispose the stator 1 in the inside of the case or the like so that the leg 40 used as a lead wire or a neutral wire is not immersed. As a result, in the stator 1, it is possible to satisfactorily reduce the cost required for insulating the conductor exposed portion of the lead wire and the neutral wire. Further, in the plurality of stator coil 3u, 3v, 3w, the crossover wire portion 41 of the first-third segment coil 4a, 4b, 4c forms an annular second coil end portion protruding outward from the end surface of the other end of the stator core 2. In the second coil end portion, the crossover wire portion 41 of the second segment coil 4b straddles the crossover wire portion 41 of the first segment coil 4a, by suppressing the overlap of the crossover wire portion 41 to two layers, in the stator 1, it is possible to satisfactorily suppress the increase in the axial length.

As described above, the stator 1 includes the first segment coil 4a, the second segment coil 4b, and the third segment coil 4c. The first segment coil 4a has a pair of legs 40 inserted into two first slots 21 spaced apart by five slots. In the second segment coil 4b, a pair of legs 40 is inserted into two second slots 22 which are separated by seven slots on both sides of the first slot 21. In the third segment coil 4c, a pair of legs 40 is inserted into predetermined first and second slots 21 and 22 spaced apart by six slots. The pair of legs 40 of the first segment coil 4a is inserted into one of the two i−1 layers and the other two i layers on one side in the circumferential direction of the two first slots 21 so as to protrude from one end of the stator core 2. The pair of legs 40 of the second segment coil 4b is inserted into one of the 2·i−1 layers and the other 2·i layers on one side in the circumferential direction of the two second slots 22 so as to protrude from one end of the stator core 2. The second segment coil 4b spans the corresponding first segment coil 4a. The pair of legs 40 of the third segment coil 4c are inserted so as to protrude from one end of the stator core 2 into one of the two i−1 layers and the other of the two i layers on one side in the circumferential direction of the predetermined first and second slots 22 spaced apart by six slots. A winding end in the 2·i layer or a winding start in the 2·i+1 layer is formed. Further, on one end side of the stator core 2, two legs 40 protrude from one of the two-i layer and the other of the two i−1 layers on one side in the circumferential direction of the first and second slots 22 separated by six slots. The two legs 40 are twisted to join the tip portions of the two. Further, on one end side of the stator core 2, two legs 40 protrude from one 2·i layer and the other 2·i+1 layer on one side in the circumferential direction of the first and second slots 22 spaced apart by six slots. The two legs 40 are twisted to join the tip portions of the two. As a result, the winding end portion in the 2·i layer and the winding start portion in the 2·i+1 layer are connected.

That is, in the parallel coil U1-U4, V1-V4, W1-W4, the first segment coil 4a is inserted into two first slots 21 spaced apart by five slots. The second segment coil 4b is inserted into two second slots 22 spaced apart by seven slots so as to straddle the first segment coil 4a. Then, at one end side of the stator core 2, the corresponding legs 40 are joined to each other at a six-slot pitch. The effective number of turns obtained by dividing the number of legs 40 (the number of layers=6) in one slot 20 by the number of parallel coil U-U4 (the number of parallel coils=4) is a non-integer (1.5 in the present embodiment). However, with the above-described configuration, the circulation current can be cancelled out in the parallel coil U1-U4, V1-V4, W1-W4, and the circulation current can be suppressed from flowing in the stator coil 3u, 3v, 3w. The circulation current is generated by a shift in the timing at which the induced voltages are generated in the magnetic poles of the parallel coil U1-U4, V1-V4, W1-W4 in accordance with the passage of the magnets of the rotor.

When the parallel coil U1 is exemplified, eight magnetic poles are formed in the parallel coil U1. As shown in FIG. 4, in the magnetic pole (winding) formed in the range from slot 8 to slot 15, the leg 40 is equally on both sides in the circumferential direction with respect to the magnetic pole center (see triangle in FIG. 4) (one each in slots 8 and 15, two each in slots 9 and 14) is arranged. Also in the magnetic poles formed in the range from the 20th slot to the 27th slot, the leg 40 is evenly arranged on both sides in the circumferential direction with respect to the magnetic pole center (2 each in the 20th and 27th slots, 1 each in the 21st and 26th slots). Further, even in the magnetic poles formed in the range from the 32nd slot to the 39th slot, the leg 40 is equally on both sides in the circumferential direction with respect to the magnetic pole center (one each in the 32nd and 39th slots, two each in the 33rd and 38th slots) are arranged. Also in the magnetic poles formed in the range from the 44th slot to the 3rd slot, the leg 40 is evenly arranged on both sides in the circumferential direction with respect to the magnetic pole center (2 each in the 44th and 3rd slots, I each in the 45th and 2nd slots). Therefore, in these magnetic poles, there is no deviation in the timing at which the induced voltage is generated in accordance with the passage of the magnet.

On the other hand, in the magnetic pole formed in the range from the 14th slot to the 21st slot, the leg 40 is biased to one side in the circumferential direction with respect to the magnetic pole center (two each in the 14th and 20th slots, one each in the 15th and 21st slots) is arranged. Further, in the magnetic pole formed in the range from the 38th slot to the 45th slot, the leg 40 is biased to one side in the circumferential direction with respect to the magnetic pole center (two each in the 38th and 44th slots, one each in the 39th and 45th slots) is arranged. Therefore, in these magnetic poles, the timing at which the induced voltage is generated in accordance with the passage of the magnet is shifted toward the leading side, for example. On the other hand, in the magnetic pole formed in the range from the 26th slot to the 33rd slot, the leg 40 is biased to the other side in the circumferential direction with respect to the magnetic pole center (one each in the 26th and 32nd slots, two each in the 27th and 33rd slots) is arranged. Further, in the magnetic pole formed in the range from the second slot to the ninth slot, the leg 40 is biased to the other side in the circumferential direction with respect to the magnetic pole center (1 each in the 2 and 8 slots, 2 each in the 3 and 9 slots) is arranged. Therefore, in these magnetic poles, the timing at which the induced voltage is generated in accordance with the passage of the magnet is shifted to, for example, the delay side. In a parallel-coil U1, two circulating currents can be cancelled out. The first is a circulation current caused by a deviation in the generation timing of an induced voltage generated by a magnetic pole formed in a range from the 14th slot to the 21st slot and a magnetic pole formed in a range from the 38th slot to the 45th slot. Second, the magnetic pole formed in the range from the 26th slot to the 33rd slot, and the circulation current due to the deviation of the generation timing of the induced voltage generated by the magnetic pole formed in the range from the 2nd slot to the 9th slot. In the stator 1, in the same manner as in the parallel coil U1, the circulating current caused by the generation timing of the induced voltage is cancelled out in the parallel coil U2-U4, V1-V4, W1-W4.

Furthermore, in the stator 1, the direction of inclination of the crossover wire portion 41 (crank portion 42) connecting the pair of legs 40 of the third segment coil 4c with respect to the radial direction of the stator core 2 is in the same direction as the first and second segment coil 4a, 4b. Therefore, the first to third segment coil 4a, 4b, 4c wound around the two i−1 layers and the two i layers can be arranged in an annular shape by a well-known annular arrangement device and then assembled to the stator core 2. As a result, it is possible to shorten the tact time and reduce the cost by omitting the use of a multi-axis robot or the like. As a result, in the stator 1, it is possible to suppress generation of a circulating current even if the effective number of turns is a non-integer, and to improve productivity and reduce the manufacturing cost.

Further, in the stator 1, the legs 40 of the third segment coil 4c protrude from one of the 2·i+1 layers on one side in the circumferential direction of the predetermined first and second slots 21 and 22. The leg 40 then protrudes from the 2·i layer of the slot 20, which is spaced by 6 slots from the one of the predetermined first and second slots 21, 22. On one end side of the stator core 2, the legs 40 are twisted to join the tip portions of the two, thereby forming a crossover wire portion 47. Further, the legs 40 of the third segment coil 4c protrude from the other 2·i layers of the predetermined first and second slots 21, 22 that are opposed to the one side. The leg 40 then protrudes from the 2·i+1 layer of the slot 20 that is spaced by 6 slots from the other of the predetermined first and second slots 21, 22. On one end side of the stator core 2, the legs 40 are twisted to join the tip portions of the two, thereby forming a crossover wire portion 47. That is, in the stator 1, the leg 40 of the third segment coil 4c forming the winding end portion in the 2·i layer or the winding start portion in the 2·i+1 layer and the other leg 40 corresponding thereto form the crossover wire portion 47. The crossover wire portion 47 crosses the layer in a direction opposite to the other crossover wire portions 45. Accordingly, the second segment coil 4b are disposed in the stator core 2 so as to straddle the corresponding first segment coil 4a, and at one end of the stator core 2, the corresponding legs 40 can be joined at 6-slot pitch.

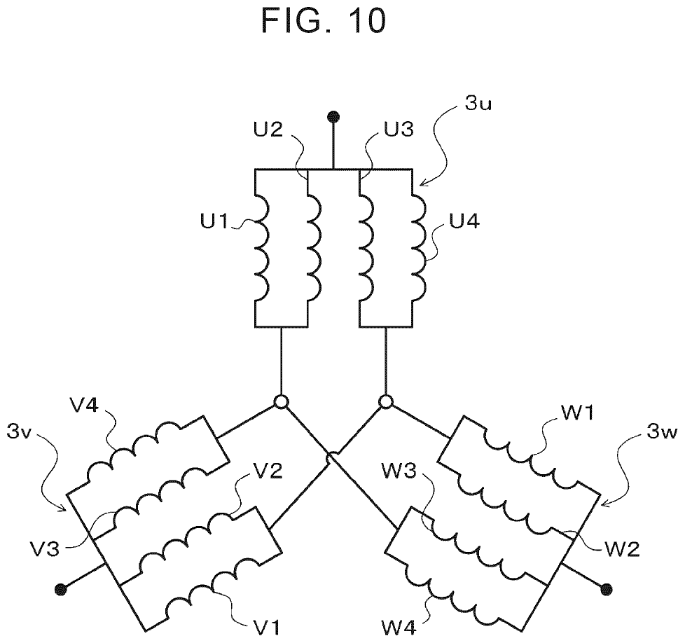

Further, a part of the leg 40 protruding from one end of the stator core 2 is used as a lead line, and is connected to a power line of a U phase, a V phase, or a W phase to which electric power is applied. Further, in the stator 1, the plurality of stator coils 3u, 3v, 3w are connected by a Y-connection, and a part of the legs 40 protruding from one end of the stator core 2 is used as a neutral wire connected to a neutral point. As a result, the lead wires and the neutral wires can be aggregated on one end side of the stator core 2, thereby simplifying the arrangement of power lines and the like and the structure of the bus bar unit. However, the plurality of stator coil 3u, 3v, 3w need not necessarily be connected by the Y-connection, and may be connected by the delta-connection or the open-connection. Further, the plurality of stator coil 3u, 3v, 3w may be constituted by parallel coil U1-U4, V1-V4, W1-W4 connected as shown in FIG. 10.

Further, in the stator 1, the number of layers 2·imax in each slot 20 may be an even number larger than 6, and the number of parallel coils in each stator coil 3u, 3v, 3w may be a multiple of 4=4·m (where “m” is an integer of 1 or more). Further, the combination of the number 2·imax of layers in each slot 20 and the number 4·m of parallel coils in each stator coil 3u, 3v, 3w (2·imax, 4·m) is not limited to (6, 4) in the above embodiment, for example, may be any of (10, 4) and (12, 8).

It is needless to say that the disclosure of the present disclosure is not limited to the above-described embodiments, and various modifications can be made within the scope of the extension of the present disclosure. Furthermore, the above-described embodiment is only a specific form of the disclosure described in the column of the outline of the disclosure, and does not limit the elements of the disclosure described in the column of the outline of the disclosure.

The disclosure of the present disclosure can be used in the manufacturing industry of stators and the like.

What is claimed is:

1. A stator comprising:
a stator core including a plurality of slots formed at intervals in a circumferential direction so as to extend in a radial direction; and
a plurality of segment coils that has a pair of legs inserted into different slots and that forms a plurality of stator coils by electrical connection between tip portions of the corresponding legs, wherein:
when a number of poles is “p” and a number of the slots is “n”, n=6·p is satisfied;
the stator coils include 4·m (where “m” is an integer of 1 or more) parallel coils connected in parallel;
an even number of the legs are inserted into each of the slots, side by side in the radial direction;
the segment coils include
a first segment coil having a pair of legs inserted into a (2·i−1)-th layer (where “i” is an integer greater than or equal to 1, i=1, . . . , imax) of one of two first slots, five slots away from each other, on one side in the circumferential direction and a (2·i)-th layer of the other so as to protrude from one end of the stator core,
a second segment coil having a pair of legs inserted into the (2·i−1)-th layer of one of two second slots, seven slots away from each other on both sides of the first slots, on the one side in the circumferential direction and the (2·i)-th layer of the other so as to protrude from the one end of the stator core, the second segment coil straddling the corresponding first segment coil, and
a third segment coil having a pair of legs inserted into the (2·i−1)-th layer of one of a predetermined first slot and a predetermined second slot, six slots away from each other, on the one side in the circumferential direction and the (2·i)-th layer of the other so as to protrude from the one end of the stator core, the third segment coil forming a winding end portion in the (2·i)-th layer or a winding start portion in a (2·i+1)-th layer; and
on a side of the one end of the stator core, two legs protruding from the (2·i)-th layer of one of the first and second slots, six slots away from each other, on the one side in the circumferential direction and the (2·i−1)-th layer of the other are twisted to join tip portions of the two legs, and two legs protruding from the (2·i)-th layer of one of the first and second slots, six slots away from each other, on the one side in the circumferential direction and the (2·i+1)-th layer of the other are twisted to join tip portions of the two legs so that the winding end portion of the (2·i)-th layer and the winding start portion of the (2·i+1)-th layer are connected.

2. The stator according to claim 1, wherein:
on the side of the one end of the stator core, the leg of the third segment coil protruding from the (2·i+1)-th layer of one of the predetermined first slot and the predetermined second slot on the one side in the circumferential direction and the leg protruding from the (2·i)-th layer of the slot, six slots away from the one of the predetermined first slot and the predetermined second slot on the one side, are twisted to join tip portions of the two legs; and
on the side of the one end of the stator core, the leg of the third segment coil protruding from the (2·i)-th layer of the other of the predetermined first slot and the predetermined second slot on a side opposite to the one side and the leg protruding from the (2·i+1)-th layer of the slot, six slots away from the other of the predetermined first slot and the predetermined second slot, are twisted to join tip portions of the two legs.

3. The stator according to claim 1, wherein a part of the legs protruding from the one end of the stator core is connected to a power line to which electric power is applied.

4. The stator according to claim 3, wherein:
the stator coils are connected by a Y-connection; and
a part of the legs protruding from the one end of the stator core is connected to a neutral point.

5. The stator according to claim 1, wherein a combination (2·imax, 4·m) of a number 2·imax of layers in the slots and a number 4·m of the parallel coils is one of (6, 4), (10, 4), and (12, 8).
